(19) United States
(12) Patent Application Publication
(10) Pub. No.: US 2012/0203503 A1
(43) Pub. Date: Aug. 9, 2012

(54) ELECTRONIC DEVICE, PEDOMETER, AND PROGRAM

(76) Inventor: Hisao Nakamura, Chiba-shi (JP)

(21) Appl. No.: 13/362,203

(22) Filed: Jan. 31, 2012

(30) Foreign Application Priority Data
Feb. 3, 2011 (JP) 2011-021431

(51) Int. Cl. G01C 22/00

(52) U.S. Cl. 702/160

(57) ABSTRACT

To allow reliable input of a switch based on an acceleration signal from a user during walking. An electronic device includes a display section displaying information on a display section, a first acceleration sensor detecting acceleration in a direction perpendicular to the display face, and an input detection section detecting input based on the acceleration detected by the first acceleration sensor.

### FIELD OF THE INVENTION

The present invention relates to an electronic device, a pedometer, and a program.

### BACKGROUND ART

A wristwatch-type pedometer for counting the number of steps based on an acceleration signal has conventionally been known. As the pedometer of this type is reduced in size, it is becoming more difficult to provide both of visibility of a display section and operability of switches.

Patent Document 1 (JP-A-2008-33526) has described a portable electronic device which achieves control such that predetermined computations are performed on the basis of acceleration detected by the portable electronic device to produce an evaluation signal indicating the amplitude and the positive/negative polarity of the acceleration, it is determined on the basis of the evaluation signal whether or not the portable electronic device is subjected to a predetermined motion, and a predefined operation is performed on the basis of the determination result.

In the portable electronic device described in Patent Document 1, however, it is impossible to distinguish between acceleration produced in the electronic device due to walking or running and acceleration produced in the electronic device due to the predetermined motion, so that the predetermined operation may not be performed. Thus, the portable electronic device described in Patent Document 1 has a drawback in that it may not operate in accordance with the motion of a user while the user walks or runs.

### SUMMARY OF THE INVENTION

It is an aspect of the present application to provide an electronic device, a pedometer, and a program capable of operation in accordance with the motion of a user while the user walks or runs.

(1) According to another aspect, the present application provides an electronic device including a display section displaying information on a display face, a first acceleration sensor detecting acceleration in a direction perpendicular to the display face, and an input detection section detecting input based on the acceleration detected by the first acceleration sensor.

(2) According to another aspect of the present application, the acceleration detector described above further includes a prior operation determination section detecting that the acceleration detected by the first acceleration sensor is smaller than a predefined value, and an operation determination section detecting the presence or absence of predefined input operation by a user based on the acceleration detected by the first acceleration sensor in response to the detection result of the prior operation determination section, wherein the input detection section detects the input based on the detection result of the operation determination section.

(3) According to another aspect of the present application, in the acceleration detector described above, the operation determination section detects the presence or absence of the input operation based on an orientation and a magnitude of the acceleration detected by the first acceleration sensor.

(4) According to another aspect of the present application, in the acceleration detector described above, the operation determination section detects the presence or absence of the input operation through the use of a change of the acceleration detected by the first acceleration sensor from positive to negative.

(5) According to another aspect of the present application, in the acceleration detector described above, the prior operation determination section detects that the acceleration detected by the first acceleration sensor is equal to or lower than a predefined value, the operation determination section detects that a second operation is present if acceleration produced when the user swings up his arm in a direction of the display face is larger than a predefined value and if the acceleration larger than the predefined value becomes smaller than a second predefined value within a predefined time period after the acceleration is observed, and the input detection section detects input based on the detection result of the operation determination section.

(6) According to another aspect of the present application, the acceleration detector described above further includes a second acceleration sensor detecting acceleration in a direction perpendicular to the direction of the acceleration detected by the first acceleration sensor, a third acceleration sensor detecting acceleration in a direction perpendicular to the direction of the acceleration detected by the first acceleration sensor and to the direction of the acceleration detected by the second acceleration sensor, and a walking determination section detecting walking based on the accelerations detected by the first, second, and third acceleration sensors and performing counting.

(7) According to another aspect of the present application, the acceleration detector described above further includes an input control section controlling another device based on the input detected by the input detection section.

(8) According to another aspect of the present application, in the acceleration detector described above, switch operation is performed including recording a lap time in a stopwatch based on the input detected by the input detection section.

(9) According to another aspect of the present application, in the acceleration detector described above, the input control section includes a control unit for switching whether another device is controlled or not.

(10) According to another aspect of the present application, the acceleration detector described above includes both of a mechanical switch and the switch operation based on the input detected by the input detection section as input units.

(11) According to another aspect of the present application, the electronic device is a pedometer.

(12) According to another aspect, the present application provides a program for causing a computer in an acceleration detector including a display section displaying information on a display face and a first acceleration sensor detecting acceleration in a direction perpendicular to the display face to perform an input detection procedure for detecting input based on the acceleration detected by the first acceleration sensor.

According to the present application, the input of the switch based on an acceleration signal from the user during walking can be performed reliably.

### BRIEF DESCRIPTION OF THE DRAWINGS

FIG. 1 is an external view of a pedometer according to an embodiment of the present invention.

FIG. 2 is a schematic block diagram of the pedometer according to the present embodiment.

FIG. 3 is a graph representing an example of an acceleration signal detected by the pedometer in the present embodiment.

FIG. 4 is a graph representing an example of an acceleration signal detected by the pedometer in the present embodiment when a user walks while looking at a wristwatch.

FIG. 5 is a graph representing a combination value of accelerations detected by the pedometer in the present embodiment.

FIG. 6 is a graph representing an example of an acceleration signal detected by the pedometer when a user is performing a shock motion in the present embodiment.

FIG. 7 is a flow chart showing an example of operation of the pedometer according to the present embodiment.

### DETAILED DESCRIPTION OF THE INVENTION

An embodiment of the present invention will hereinafter be described in detail with reference to the drawings. In the present embodiment, description is made with an example of a pedometer, as an exemplary acceleration detector.

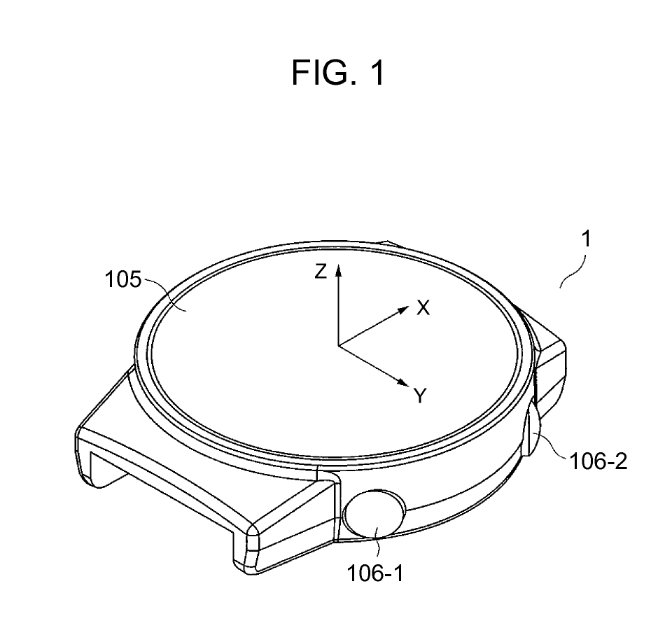

FIG. 1 is an external view showing the outer appearance of the pedometer. In the example shown, the pedometer 1 includes a display section 105 on an upper face, and input sections 106-1 and 106-2 (mechanical switches) on a side face.

The display section 105 includes a display face to display the number of steps and the time measured by a stopwatch function.

The input switches 106-1 and 106-2 receive input of an instruction from a user to start or stop the pedometer or to store a lap time in a stopwatch mode.

The same plane as the display face of the display section 105 is defined as an XY plane, a direction of 6-to-0 o'clock is defined as an X axis, and a direction of 9-to-3 o'clock is defined as Y axis. A direction perpendicular to the display face of the display section 105 and extending from the back side toward the display face of the pedometer (thickness direction of the pedometer 1) is defined as a positive direction of a Z axis.

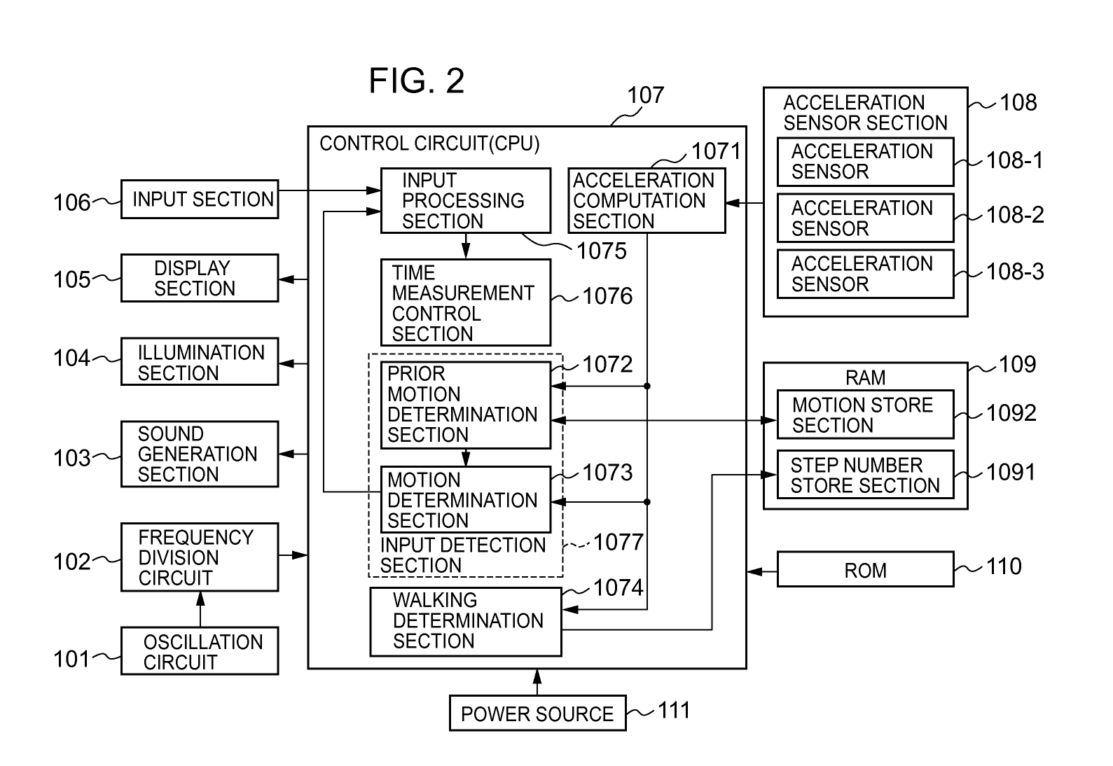

FIG. 2 is a schematic block diagram of the pedometer 1 according to the embodiment of the present invention. In this figure, the pedometer 1 includes an oscillation circuit 101, a frequency division circuit 102, a sound generation section 103, an illumination section 104, the display section 105, the input section 106, a control circuit (CPU: Central Processing Unit) 107, an acceleration sensor section 108, a RAM (Random Access Memory) 109, a ROM (Read Only Memory) 110, and a power source 111. The control circuit 107 includes an acceleration computation section 1071, a prior motion determination section 1072, a motion determination section 1073, a walking determination section 1074, an input processing section 1075, and a time measurement control section 1076. The acceleration sensor section 108 includes an acceleration sensor 108-1 (first acceleration sensor for a Z-axis direction), an acceleration sensor 108-2 (second acceleration sensor for an X-axis or Y-axis direction), and an acceleration sensor 108-3 (third acceleration sensor for the X-axis or Y-axis direction). The RAM 109 includes a step number store section 1091 and a motion store section 1092.

The oscillation circuit 101 produces a signal at a predetermined frequency and outputs the produced signal to the frequency division circuit 102.

The frequency division circuit 102 divides the frequency of the signal input from the oscillation circuit 101 to produce a reference signal for the operation of the control circuit 107.

The sound generation section 103 performs sound generation such as generation of a time signal based on sound generation information input from the control circuit 107 for outputting sound.

The illumination section 104 illuminates the display section 105 based on illumination information input from the control circuit 107.

The display section 105 receives input of display information such as the number of steps or the time from the control section 107 and displays the display information on the display face.

The input section 106 includes the mechanical switches 106-1 and 106-2 and receives input from a user, for example, input for starting or stopping the pedometer, input of a time of day provided by a watch function, input for setting an alarm or the like. Upon reception of such input, the input section 106 outputs the input information to the input processing section 1075.

The control circuit 107 is formed mainly of the CPU, operates in response to input of the reference signal produced by the frequency division circuit, and performs detection of acceleration, detection of shock, detection of walking or the like.

The acceleration computation section 1071 A/D-converts accelerations of three-axis directions input from the acceleration sensor section 108 and outputs acceleration information indicating the accelerations after the conversion.

The prior motion determination section 1072 determines whether or not a Z-axis component of the acceleration indicated by the acceleration information input from the acceleration computation section 1071 is smaller than a given value. Specifically, the prior motion determination section 1072 determines whether or not a user is walking and performing a preliminary motion (referred to as a prior motion) of moving his arm portions forward and backward along a portion near his stomach or waist that is necessary for input to the pedometer 1. The details of the determination of the prior motion are described later.

When the prior motion determination section 1072 determines that the user is performing the prior motion, it outputs shock motion information indicating that the user is performing the prior motion to the motion determination section 1073. When the prior motion determination section 1072 does not determine that the user is performing the prior motion, it writes a prior motion value indicating the Z-axis direction component of the acceleration to the motion store section 1092.

When the shock motion information is input from the prior motion determination section 1072, the motion determination section 1073 determines the presence or absence of shock in response to the motion input from the user based on the Z-axis component of the acceleration indicated by the acceleration information input from the acceleration computation section 1071. The details of the determination of shock are described later. When the motion determination section 1073 determines that shock is present, it outputs shock occurrence information indicating that the shock is present to the input processing section 1075. When the motion determination section 1073 determines that shock is absent, it writes the prior motion value to the motion store section 1092. The prior motion determination section 1072 and the motion determination section 1073 are also referred to as an input detection section 1077.

The walking determination section 1074 detects a walking motion based on the acceleration indicated by the acceleration information input from the acceleration computation section 1071. The details of the detection of the walking motion are described later. When the walking determination section 1074 determines that the user is walking, it reads the current step number information from the step number store section 1091 and writes the value calculated by adding “one” to the read current step number as step number information to the step number store section 1091.

The input processing section 1075 outputs time measurement control information such as a time measurement start command, a time measurement stop command, or a lap time measurement command to the time measurement control section 1076 based on the information input from the input section 106 and the shock occurrence information input from the motion determination section 1073.

The time measurement control section 1076 controls the functions such as a pedometer mode, a stopwatch mode, and a watch mode based on the time measurement control information indicated by the input processing section 1075.

The acceleration sensor 108 detects the accelerations in three-axis directions orthogonal to each other in the orthogonal coordinate system defined in FIG. 1 and outputs the detected accelerations to the acceleration computation section 1071.

The RAM 109 stores the data written by the control circuit 107 or the like for temporary save. The step number store section 1091 records the step number information written by the walking determination section 1074. The motion store section 1092 records the prior motion value output by the prior motion determination section 1072 or the motion determination section 1073.

The motion store section 1092 is a store section of an FIFO (First In First Out) type, and for example, saves 10 items of data in order from the latest input item and abandons the older data.

The ROM 110 stores a program to be executed by the control circuit 107. The ROM 110 reads the program to the control circuit 107 for execution by the control circuit 107.

The power source 111 supplies power to the respective sections of the pedometer.

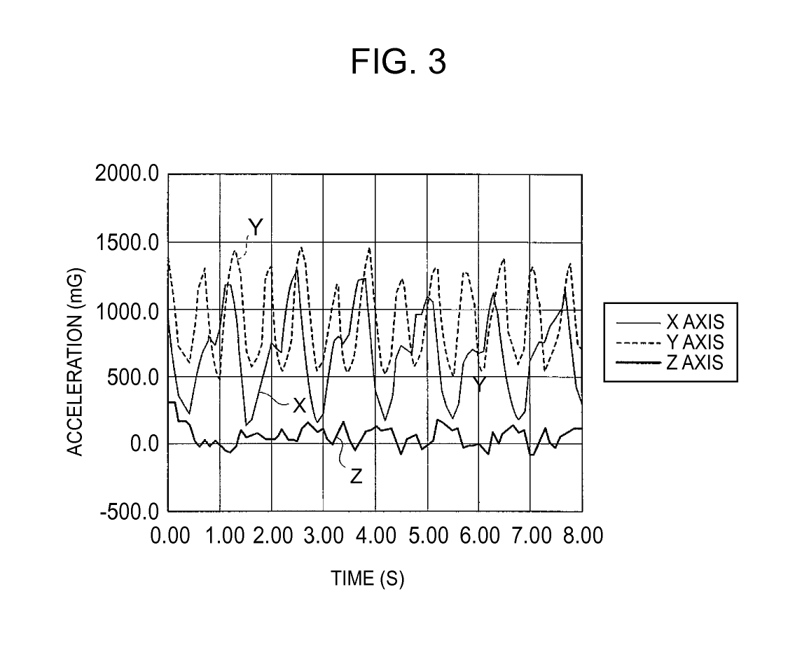

FIG. 3 is a graph representing an acceleration signal detected by the pedometer 1. FIG. 3 is the graph showing an example of the acceleration observed when the user puts the wristwatch-type pedometer on the back side of his wrist and walks with his arms moving forward and backward. In the example shown, the horizontal axis represents time and the vertical axis represents the acceleration (mG).

In FIG. 3, a curve with a character X represents an X-axis component of the acceleration. A curve with a character Y represents a Y-axis component of the acceleration. A curve with a character Z represents a Z-axis component of the acceleration.

Description will be made of the acceleration detected by the acceleration sensor when the user puts the wristwatch-type pedometer on the back side of his wrist and walks with his arms moving forward and backward with reference to FIG. 3.

When the user walks with the wristwatch-type pedometer, the user is usually performing the motion of moving his arms forward and backward. In association with the motion, the acceleration has large values and amplitudes in the XY plane defined in FIG. 1.

As shown in FIG. 3, acceleration levels in the neighborhood of 1G of the acceleration of gravity are observed in the X-axis and Y-axis components. Since those acceleration levels are allocated to the X-axis and Y-axis components, the components have large amplitudes and relatively large variations. In contrast, the Z-axis component has a small amplitude and relatively small variations.

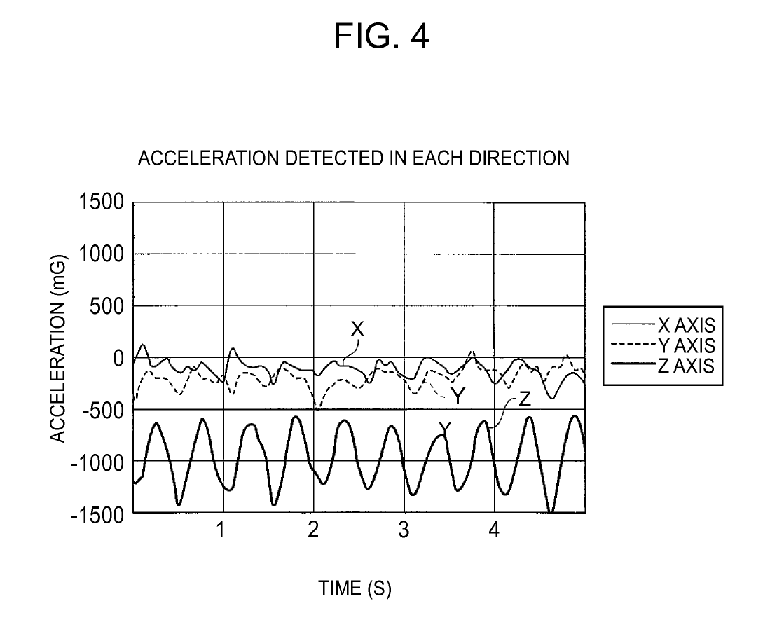

FIG. 4 is a graph representing the acceleration signal detected by the pedometer when the user walks while looking at the wristwatch. FIG. 4 shows an example of the acceleration observed when the user puts the wristwatch-type pedometer on the back side of his wrist and walks while looking at the display section 105. In the example shown, the horizontal axis represents time and the vertical axis represents the acceleration (mG).

In FIG. 4, a curve with a character X represents an X-axis component of the acceleration. A curve with a character Y represents a Y-axis component of the acceleration. A curve with a character Z represents a Z-axis component of the acceleration.

Description will be made of the acceleration signal detected by the acceleration sensor when the user walks while looking at the display section 105 with reference to FIG. 4.

When the user wears the wristwatch-type pedometer and walks while looking at the display section 105, the shock of the walking shakes the pedometer upward and downward. In association with the motion, the acceleration has a large value and amplitude in the Z-axis direction defined in FIG. 1.

As shown in FIG. 4, the Z-axis component shows large acceleration levels in the neighborhood of 1G of the acceleration of gravity and has large variations. In contrast, the X-axis and Y-axis components have small amplitudes and relatively small variations.

The pedometer 1 detects the walking with a combination value obtained by combining the accelerations in the X-axis, Y-axis, and Z-axis directions.

Specifically, the walking determination section 1074 calculates the combination value of the accelerations based on the accelerations indicated by the acceleration information input from the acceleration computation section 1071. When the acceleration in the X-axis direction is represented by X, the acceleration in the Y-axis direction is represented by Y, and the acceleration in the Z-axis direction is represented by Z, then the combination value of the accelerations is calculated with the following expression (1), for example:

(X̂2+Ŷ2)̂0.5+Z (1)

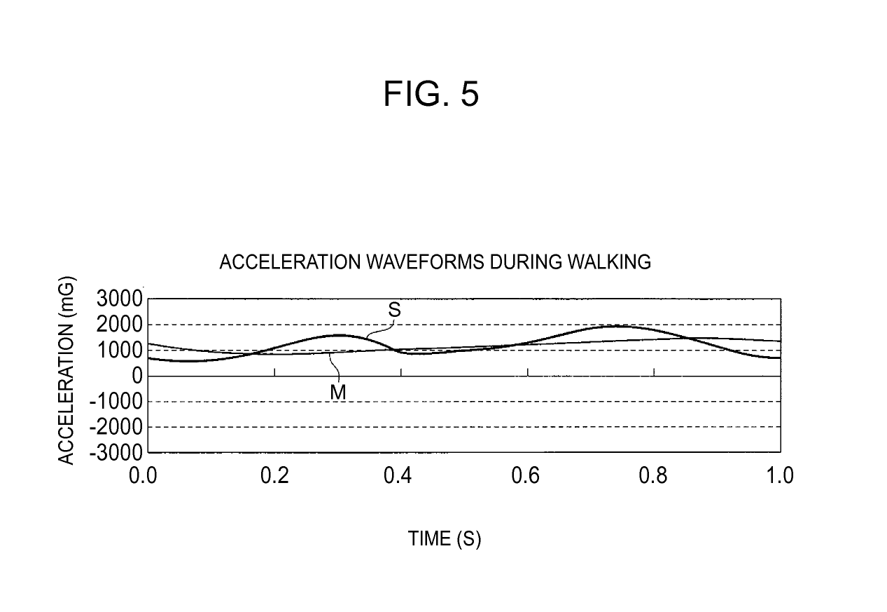

FIG. 5 shows a graph representing the combination value of the accelerations detected by the pedometer 1. In this example shown, the horizontal axis represents time and the vertical axis represents the acceleration (mG). A curve with a character S shows an example of a waveform S representing the combination value of the accelerations indicated by the acceleration signal during walking. A curve with a character M shows an example of a waveform M representing the moving average of the waveform S. The waveform M representing the moving average is provided by sampling the combination value of the accelerations calculated with the expression 1, for example ten times, and calculating the moving average thereof.

The walking determination section 1074 determines walking based on the shapes of the waveform S and the waveform M in FIG. 5. Specifically, the walking determination section 1074 detects the point of the waveform S that intersects the waveform M from below upward to determine that “one step” of walking is performed. Alternatively, the walking determination section 1074 may determine that “one step” of walking is performed when it detects the point of the waveform S that intersects the waveform M from above downward.

The walking determination section 1074 may calculate the combination value of the acceleration signal with the following expression (2).

(X̂2+Ŷ2)̂0.5+|Z| (2)

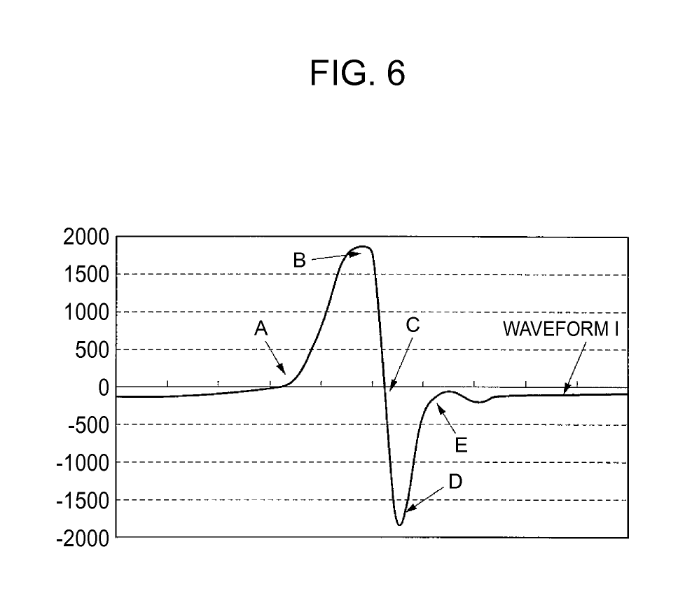

FIG. 6 shows a graph representing a waveform I of the Z-axis component of the acceleration observed when the wristwatch-type pedometer put on the arm of the user for use strikes a portion near his stomach or waist.

In the present embodiment, such a shock motion of the user is also received as input to the pedometer 1. The waveform I shows that the acceleration is almost zero before the shock is given to the pedometer 1 (from start to near A). The acceleration given to the pedometer 1 is in the positive direction of the Z axis at early stages of the shock (from A to near B). After the acceleration reaches the maximum value (near B), the acceleration immediately increases in a negative direction of the Z axis, and after it reaches the minimum value (near D), it returns to near zero (near E).

FIG. 6 is the graph showing an example of the magnitude of the Z-axis component of the acceleration observed when the user puts the wristwatch-type pedometer on the back side of his arm portion. If the user puts the wristwatch-type pedometer on the palm side of his hand, the waveform has a shape with reversed positive and negative directions.

In this manner, the acceleration given to the wristwatch-type pedometer greatly varies with the orientation of the pedometer and the motion of the body of the user. The determination whether the input of a shock switch is performed or not is made in two-stage determination including first determination and second determination.

The prior motion determination section 1072 performs the first determination (prior motion determination).

The prior motion determination section 1072 determines whether or not the moving average value of the Z-axis components of the acceleration in a time-axis direction (for example, the average of the values from the sampling of the Z-axis component of the acceleration performed approximately ten times) is equal to or lower than 500 mG, for example. The movement average value is calculated on the basis of the previous prior motion value stored in the motion store section 1092.

This state corresponds to the state found when the user walks or runs with his hands moving forward and backward (see FIG. 3). The prior motion for actually performing the shock switch input to the pedometer such as LAP operation corresponds to this motion.

On the other hand, for example when the user looks at the display of the wristwatch-type pedometer (see FIG. 4), the absolute value of the moving average value of the Z-axis components of the acceleration in the time-axis direction is significantly higher than 500 mG. Thus, the first determination does not provide a positive result, and the determination of input of the shock switch is not performed.

When it is determined that the result of the prior motion determination is positive (the state in which the input of the shock switch is possible), control proceeds to the second determination.

The motion determination section 1073 performs the second determination (shock determination). The shock determination is performed by using the characteristics of the acceleration waveform (FIG. 6) found when the arm portion strikes a portion near the user's stomach or waist.

The motion determination section 1073 determines that the result of the second determination is positive (the input of the shock switch is present) when both of the following two conditions are satisfied. A first condition is that the acceleration in the Z-axis direction is equal to or higher than 750 mG, for example (referred to as a condition a). A second condition is that the acceleration in the Z-axis direction becomes equal to or lower than, for example, −750 mG, within, for example, 100 ms after the condition a is satisfied. Only when both of the two conditions are satisfied, it is determined that the result of the second determination is positive.

The input detection section 1077 determines that the input of the shock switch is present when the motion determination section 1073 determines that the result of the second determination is positive.

Next, the operation of the pedometer 1 according to the present embodiment will be described.

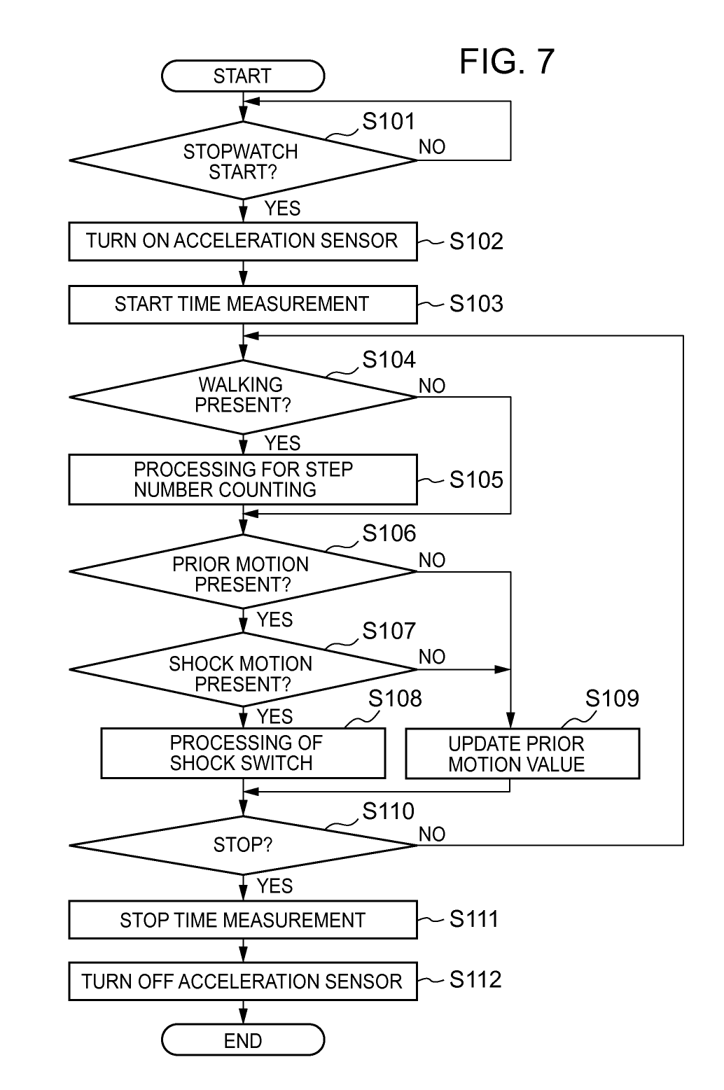

FIG. 7 is a flow chart showing an example of operation for changing the pedometer 1 according to the present invention to a stopwatch mode to perform input for lap measurement with the shock switch.

(Step S101) The input processing section 1075 determines whether or not the stopwatch should start time measurement based on whether or not input is received from the input section 106 to start the stopwatch. When it is determined that the stopwatch should start time measurement (Yes), the control proceeds to step S102. When it is determined that the stopwatch should not start time measurement (No), the control returns to step S101.

(Step S102) The acceleration computation section 1071 outputs a command for starting the detection of acceleration in the three-axis directions to the acceleration sensor section 108. The acceleration sensor section 108 receives the command for starting the detection of acceleration in the three-axis directions from the acceleration computation section 1071 and starts the detection of acceleration in the three-axis directions. The acceleration sensor section 108 outputs the detected acceleration in the three-axis directions to the acceleration computation section 1071. The acceleration computation section 1071 A/D-converts the acceleration in the three-axis directions input from the acceleration sensor section 108 and outputs an acceleration signal indicating the acceleration to the prior motion determination section 1072, the motion determination section 1073, and the walking determination section 1074. Then, the control proceeds to step S103.

(Step S103) The input processing section 1075 outputs a time measurement start command to the time measurement control section 1076. The time measurement control section 1076 receives the input of the time measurement start command from the switch control section 1075 and starts time measurement. Then, the control proceeds to step S104.

(Step S104) The walking determination section 1074 receives the input of the acceleration information from the acceleration computation section 1071. The walking determination section 1074 determines walking based on the acceleration indicated by the input acceleration information. When it is determined that walking is present (Yes), the control proceeds to step S105. When it is determined that walking is not present (No), the control proceeds to step S106.

(Step S105) The step number determination section 1074 reads the information about the current number of steps from the step number store section 1091. The step number determination section 1074 writes the value calculated by adding one to the read value to the step number store section 1091 as information about the number of steps. Then, the control proceeds to step S106.

(Step S106) The prior motion determination section 1072 receives the input of the acceleration information from the acceleration computation section 1071. The prior motion determination section 1072 reads the prior motion value stored in the motion store section 1092. The prior motion determination section 1072 calculates the average value of the prior motion values based on the Z-axis component of the acceleration indicated by the acceleration information input from the acceleration computation section 1071 and the prior motion value stored in the motion store section 1092.

The prior motion determination section 1072 determines whether or not the average of the prior motion values is equal to or lower than 500 mG, for example. When it is determined that the average value of the prior motion values is equal to or lower than 500 mG (Yes), the control proceeds to step S107. When it is determined that the average value of the prior motion values is not equal to or lower than 500 mG (No), the control proceeds to step S109.

(Step S107) When the motion determination section 1073 receives the input of the shock motion information from the prior motion determination section 1072, it receives the input of the acceleration information from the acceleration computation section 1071, and performs shock determination based on the change in the Z-axis direction of the acceleration indicated by the acceleration information.

The shock determination provides a positive result (input of the shock switch is present) when the following two conditions are satisfied.

(a) The acceleration in the Z-axis direction is equal to or higher than 750 mG, for example.

(b) The acceleration in the Z-axis direction becomes equal to or lower than, for example −750 mG, within, for example 100 ms from the time of the detection of the condition (a).

Only when both of the two conditions (a) and (b) are satisfied, it is determined that the shock switch input is present. When it is determined that the shock switch input is present (Yes), the control proceeds to step S108. When it is determined that the shock switch input is not present (No), the control proceeds to step S109.

(Step S108) In response to the shock switch input from the motion determination section 1073, the input processing section 1075 outputs a predefined command to the time measurement control section. The command may be for stopping time measurement in the stopwatch (time measurement stop command) or for lap measurement in the stopwatch (lap time measurement command), for example. Then, the control proceeds to step S110.

(Step S109) The motion store section 1092 receives the input of the prior motion value (value of the Z-axis component of the acceleration) from the prior motion determination section 1072 or the motion determination section 1073. Then, the control proceeds to step S110.

(Step S110) The input processing section 1075 monitors input from the input section 106 indicating that the time measurement of the stopwatch should be stopped, and determines whether or not the time measurement of the stopwatch should be stopped.

When it is determined that the time measurement of the stopwatch should be stopped (Yes), the control proceeds to step S111. When it is determined that the time measurement of the stopwatch should not be stopped (No), the control returns to step S104.

(Step S111) The input processing section 1075 outputs the time measurement stop command to the time measurement control section 1076. The time measurement control section 1076 receives the input of the time measurement stop command from the switch control section 1075 and stops the time measurement. Then, the control proceeds to step S112.

(Step S112) The control circuit 107 causes the acceleration sensor section 108 to stop the detection of the acceleration in the three-axis directions.

While the present embodiment shows the case in which the wristwatch-type pedometer is put on the back side of the user's hand, the wristwatch-type pedometer may be put on the palm side of the user's hand. In this case, in the shock determination, an acceleration signal is observed first on the negative side of the Z axis and then observed on the positive side. In this case, the shock determination may be performed in the reversed positive and negative relationship.

While the present embodiment shows the example in which the shock switch is used for stopping the time measurement in the stopwatch or the lap measurement in the stopwatch, the shock switch may be used for input of various commands other than the abovementioned uses. The shock switch may be activated or deactivated by the user.

In this manner, according to the present embodiment, the pedometer 1 includes the display section 105 displaying the information on the display face, the acceleration sensor 108-1 detecting the acceleration in the direction perpendicular to the display face, and the input detection section 1077 detecting the input based on the acceleration detected by the acceleration sensor 108-1. Thus, the user can give the acceleration in the direction perpendicular to the display section 105 of the pedometer 1 to perform the input of the shock switch to the pedometer 1.

According to the present embodiment, the pedometer 1 detects whether the motion in the Z-axis direction is smaller or not based on the acceleration detected by the acceleration sensor 108-1, and when the motion in the Z-axis direction is small, detects whether or not the shock motion is present based on the acceleration detected by the acceleration sensor 108-1. When the shock motion is detected, the input detection section 1077 detects the switch input. Thus, the motion performed by the user such as looking at the display section 105 can be prevented from being erroneously detected as the shock switch input in the pedometer 1.

According to the present embodiment, the input detection section 1077 detects whether the shock motion is present or not based on the orientation and the magnitude of the acceleration detected by the acceleration sensor 108-1. This allows the pedometer 1 to detect the acceleration changes characteristic of the shock motion to enable the reliable detection of the shock switch input.

According to the present embodiment, the motion determination section 107 detects the presence or absence of the shock motion using the change of the acceleration detected by the acceleration sensor 108-1 from positive to negative directions. Thus, the pedometer 1 can detect the acceleration changes characteristic of the shock motion and can distinguish the input of the shock switch from the acceleration produced when the arm with the acceleration detector put thereon strikes another object such as a wall.

According to the present embodiment, the prior motion determination section 1072 detects whether or not the moving average value of the accelerations in the Z-axis direction detected by the acceleration sensor 108-1 is equal to or lower than 500 mG. If the moving average value of the accelerations in the Z-axis direction is equal to or lower than 500 mG, the motion determination section 1073 then detects whether or not the shock motion is present when the acceleration produced in swinging up the arm with the acceleration detector put thereon in the direction of the display face is higher than, for example 750 mG, and then the acceleration becomes equal to or lower than −750 mG within, for example 100 ms. When the determination result of the motion determination section 1073 is positive, the input detection section 1077 detects the input. Thus, the pedometer 1 detects whether or not the shock switch input motion of the user's arm portion striking a portion near his stomach or waist is performed after the prior motion of the switch input. Consequently, the pedometer 1 can detect that the input of the shock switch is present during the walking motion.

According to the present embodiment, the step number determination section 1074 detects walking with the acceleration in the three-axis directions output by the acceleration sensor 108-1 detecting the acceleration in the Z-axis direction and by the acceleration sensors 108-2 and 108-3 detecting the acceleration in the X-axis and Y-axis directions. This enables both of the walking detection and the input of the shock switch.

According to the present embodiment, the switch input processing section 1075 controls the time measurement control section 1076 or the controller 107 based on the switch input detected by the input detection section 1077. Thus, the shock switch can control the functions of the watch and the functions of the pedometer.

According to the present embodiment, the switch operation can be performed including the lap operation of the stopwatch based on the switch input detected by the input detection section 1077. This allows the shock switch to perform the switch operation such as the lap operation of the stopwatch while performing the step number counting.

According to the present embodiment, the user can activate or deactivate the operation of the input detection section 1077. This enables the user to select whether he uses the shock switch or not.

According to the present embodiment, the pedometer 1 has both input units of the mechanical switch and the shock switch. This allows the user to select the input through the mechanical switch or the input through the shock switch according to the circumstances.

All or some of the functions of the sections included in the pedometer according to the embodiment described above may be realized by recording a program for realizing these functions on a computer-readable recording medium, and reading the program recorded on the recording medium by a computer system for execution. The “computer system” mentioned herein includes an operating system and hardware such as peripheral devices.

The “computer-readable recording medium” refers to transportable medium such as a flexible disk, a magnet-optical disk, a ROM, and a CD-ROM, and a storage such as a hard disk contained in the computer system. The “computer-readable recording medium” may include one dynamically holding the program for a short time such as a communication line when the program is transmitted through a network such as the Internet or a communication channel such as a telephone line, one holding the program for a certain time such as a volatile memory within the computer system serving as a server or a client in that case. The abovementioned program may be one for realizing some of the abovementioned functions, or may be one capable of realizing the abovementioned functions in combination with a program previously recorded in the computer system.

Although one embodiment of the present invention has been described in detail with reference to the drawings, specific configurations are not limited to the abovementioned ones, and various design changes can be made without departing from the spirit or scope of the present invention.

What is claimed is:

1. An electronic device comprising:
a display section displaying information on a display face;
a first acceleration sensor detecting acceleration in a direction perpendicular to the display face; and
an input detection section detecting input based on the acceleration detected by the first acceleration sensor.

2. The electronic device according to claim 1, further comprising:
a prior operation determination section detecting that the acceleration detected by the first acceleration sensor is smaller than a predefined value; and
an operation determination section detecting the presence or absence of predefined input operation by a user based on the acceleration detected by the first acceleration sensor in response to the detection result of the prior operation determination section,
wherein the input detection section detects the input based on the detection result of the operation determination section.

3. The electronic device according to claim 1, wherein the operation determination section detects the presence or absence of the input operation based on an orientation and a magnitude of the acceleration detected by the first acceleration sensor.

4. The electronic device according to claim 2, wherein the operation determination section detects the presence or absence of the input operation based on an orientation and a magnitude of the acceleration detected by the first acceleration sensor.

5. The electronic device according to claim 1, wherein the operation determination section detects the presence or absence of the input operation through the use of a change of the acceleration detected by the first acceleration sensor from positive to negative.

6. The electronic device according to claim 2, wherein the operation determination section detects the presence or absence of the input operation through the use of a change of the acceleration detected by the first acceleration sensor from positive to negative.

7. The electronic device according to claim 3, wherein the operation determination section detects the presence or absence of the input operation through the use of a change of the acceleration detected by the first acceleration sensor from positive to negative.

8. The electronic device according to claim 4, wherein the operation determination section detects the presence or absence of the input operation through the use of a change of the acceleration detected by the first acceleration sensor from positive to negative.

9. The electronic device according to claim 1, wherein the prior operation determination section detects that the acceleration detected by the first acceleration sensor is equal to or lower than a predefined value,
the operation determination section detects that a second operation is present if acceleration produced when the user swings up his arm in a direction of the display face is larger than a predefined value and if the acceleration larger than the predefined value becomes smaller than a second predefined value within a predefined time period after the acceleration is observed, and
the input detection section detects input based on the detection result of the operation determination section.

10. The electronic device according to claim 2, wherein the prior operation determination section detects that the acceleration detected by the first acceleration sensor is equal to or lower than a predefined value,
the operation determination section detects that a second operation is present if acceleration produced when the user swings up his arm in a direction of the display face is larger than a predefined value and if the acceleration larger than the predefined value becomes smaller than a second predefined value within a predefined time period after the acceleration is observed, and
the input detection section detects input based on the detection result of the operation determination section.

11. The electronic device according to claim 3, wherein the prior operation determination section detects that the acceleration detected by the first acceleration sensor is equal to or lower than a predefined value,
the operation determination section detects that a second operation is present if acceleration produced when the user swings up his arm in a direction of the display face is larger than a predefined value and if the acceleration larger than the predefined value becomes smaller than a second predefined value within a predefined time period after the acceleration is observed, and
the input detection section detects input based on the detection result of the operation determination section.

12. The electronic device according to claim 4, wherein the prior operation determination section detects that the acceleration detected by the first acceleration sensor is equal to or lower than a predefined value,
the operation determination section detects that a second operation is present if acceleration produced when the user swings up his arm in a direction of the display face is larger than a predefined value and if the acceleration larger than the predefined value becomes smaller than a second predefined value within a predefined time period after the acceleration is observed, and
the input detection section detects input based on the detection result of the operation determination section.

13. The electronic device according to claim 1, further comprising:
a second acceleration sensor detecting acceleration in a direction perpendicular to the direction of the acceleration detected by the first acceleration sensor;
a third acceleration sensor detecting acceleration in a direction perpendicular to the direction of the acceleration detected by the first acceleration sensor and to the direction of the acceleration detected by the second acceleration sensor; and
a walking determination section detecting walking based on the accelerations detected by the first, second, and third acceleration sensors and performing counting.

14. The electronic device according to claim 2, further comprising:
a second acceleration sensor detecting acceleration in a direction perpendicular to the direction of the acceleration detected by the first acceleration sensor;
a third acceleration sensor detecting acceleration in a direction perpendicular to the direction of the acceleration detected by the first acceleration sensor and to the direction of the acceleration detected by the second acceleration sensor; and
a walking determination section detecting walking based on the accelerations detected by the first, second, and third acceleration sensors and performing counting.

15. The electronic device according to claim 1, further comprising an input control section controlling another device based on the input detected by the input detection section.

16. The electronic device according to claim 1, wherein switch operation is performed including recording a lap time in a stopwatch based on the input detected by the input detection section.

17. The electronic device according to claim 1, wherein the input control section includes a control unit for switching whether another device is controlled or not.

18. The electronic device according to claim 1, comprising both of a mechanical switch and the switch operation based on the input detected by the input detection section as input units.

19. The electronic device according to claim 1, wherein the electronic device is a pedometer.

20. A program for causing a computer in an acceleration detector including a display section displaying information on a display face and a first acceleration sensor detecting acceleration in a direction perpendicular to the display face to perform an input detection procedure for detecting input based on the acceleration detected by the acceleration sensor.
